(19) United States
(12) Patent Application Publication
(10) Pub. No.: US 2026/0175437 A1
(43) Pub. Date: Jun. 25, 2026

(54) CARD-READING PAINTING ROBOT

(71) Applicant: Yanliang Wang, Lanzhou (CN)

(72) Inventor: Yanliang Wang, Lanzhou (CN)

(21) Appl. No.: 18/987,618

(22) Filed: Dec. 19, 2024

(51) Int. Cl. B25J 11/00; B25J 9/10; B25J 9/16; B25J 18/00; B25J 19/00

(52) U.S. Cl. CPC B25J 11/0075; B25J 9/101; B25J 9/102; B25J 9/161; B25J 9/1679; B25J 19/005; B25J 18/005

(57) ABSTRACT

The present application relates to educational equipment, specifically discloses a card-reading painting robot, comprising a card recognition mechanism, a control and adjustment component, a right arm component, a pen lock button, an arm assembly, a left arm component, and a rising component. The lower part of the card recognition mechanism is connected to the control and adjustment component, the control and adjustment component is arranged on the arm assembly, a right arm component is placed on one side of the arm assembly, a left arm component is positioned on one side of the arm assembly, and both the right arm component and the left arm component are connected to the pen lock button.

### FIELD OF THE APPLICATION

The present application relates to the technical field of educational equipment. More specifically, the present application relates to card-reading painting robot.

### BACKGROUD

A drawing robot is a robot toy that teaches children to learn simple drawing, helping them learn while playing. The drawing robot needs to use its arms to control the pressing and lifting of the drawing pen to achieve the function of drawing on paper. Currently, when users use drawing robots, most of the instructions of the drawing robots are data stored before drawing, and the drawing content cannot be changed quickly, which makes the drawing inconvenient and affects the user experience.

Therefore, a card-reading painting robot is designed to address the above situation.

### SUMMARY

The technical problem to be solved by the present application is to overcome the defects of the above-mentioned technology and provide a card-reading painting robot.

To solve the above technical problems, the technical solution provided by the present application is a card-reading painting robot, comprising a card recognition mechanism, a control and adjustment component, a right arm component, a pen lock button, an arm assembly, a left arm component and a rising component, wherein the lower part of the card recognition mechanism is connected to the control and adjustment component, the control and adjustment component is arranged on the arm assembly, a right arm component is arranged on one side of the arm assembly, a left arm component is arranged on one side of the arm assembly, and both the right arm component and the left arm component are connected to the pen lock button, and the lower part of the arm assembly is arranged on the rising component.

The card recognition mechanism comprising a card placement plate, a recognition main board and a card recognition plate bracket. The card placement plate is arranged on the recognition main board, and the recognition main board is connected to the control and adjustment component through the card recognition plate bracket.

The control and adjustment assembly comprising a control button, a button PCBA board, a battery, a mainboard PCBA board and an isolation middle frame. The control button passes through the main body upper shell and is arranged on the button PCBA board. The button PCBA board is connected to the mainboard PCBA board. The mainboard PCBA board is provided with a battery. The lower bolt of the mainboard PCBA board is connected to the isolation middle frame.

The rising component comprising a rising component gear plate, a floating motor fixing bracket, a floating motor, a transmission gear and a floating guide column. The upper part of the rising component gear plate is arranged in the middle part below the arm connecting plate, and the rising component gear plate meshes with the transmission gear. The transmission gear is placed on the floating motor. The floating motor is fixedly connected to the lower shell of the main body through the floating motor fixing bracket. The floating guide column is slidably matched with the arm connecting plate.

As an improvement, the rising component is arranged on the lower shell of the main body, and the upper shell of the main body is arranged above the lower shell of the main body.

As an improvement, an anti-slip pad is arranged below the lower shell of the main body.

As an improvement, the arm assembly comprising an arm connecting plate, a magnetic coding switch, and an arm limit switch, a right arm component is arranged on one side of the arm connecting plate, and a left arm component is placed on the other side of the arm connecting plate, the lower part of the arm connecting plate is connected to the rising component, a magnetic coding switch and an arm limit switch are arranged on the arm connecting plate, and a magnet is placed at the lower end of the magnetic coding switch.

As an improvement, the right arm assembly is composed of a right arm connecting rod, a right forearm, and a right arm motor, the right arm motor is arranged on the arm connecting plate, the right arm motor is connected to the right forearm through the right arm connecting rod, and the right forearm is arranged on the right side of the pen lock button.

As an improvement, the left arm assembly is composed of a left forearm, a left-arm connecting rod, and a left-arm motor, the left arm motor is arranged on the arm connecting plate, the left arm motor is connected to the left forearm through the left arm connecting rod, and the left arm connecting rod is arranged on the left side of the pen lock button.

As an improvement, a drawing pen-is provided on the pen lock button.

As an improvement, a charging power supply is provided on the control and adjustment assembly, and the charging power supply-is electrically connected to the battery.

The advantages of the present application compared with the prior art are:

The painting robot is provided with a card recognition mechanism, which can read the card inserted into the card recognition mechanism, and then the main board PCBA board drives the floating motor according to the content on the read card, and lifts or lowers the arm assembly through the transmission gear and the rising component gear plate, thereby adjusting the motion parameters of the right arm assembly and the left arm assembly, and changing the height of the drawing pen; it can quickly read and identify the card content and perform painting operations, which is more convenient to use; when it is necessary to change the painting content, the card can also be quickly replaced, which increases the user experience;

The combination of the magnetic coding switch 52, the arm limit switch 53 and the magnet 54 can control the accuracy of the arm assembly painting through the sensitivity of the current to the magnetic field.

### BRIEF DESCRIPTION OF THE DRAWINGS

FIG. 1 is a perspective view of a card-reading painting robot;

FIG. 2 is a top perspective view of a card-reading painting robot in separate condition thereof;

FIG. 3 is a bottom perspective view of a card-reading painting robot in separate condition thereof;

FIG. 4 is a perspective view of the structure of a card-reading painting robot card recognition mechanism;

FIG. 5 is a perspective view of the disassembled state of a card-reading painting robot; and

FIG. 6 is a perspective view of the disassembled state of a card-reading painting robot.

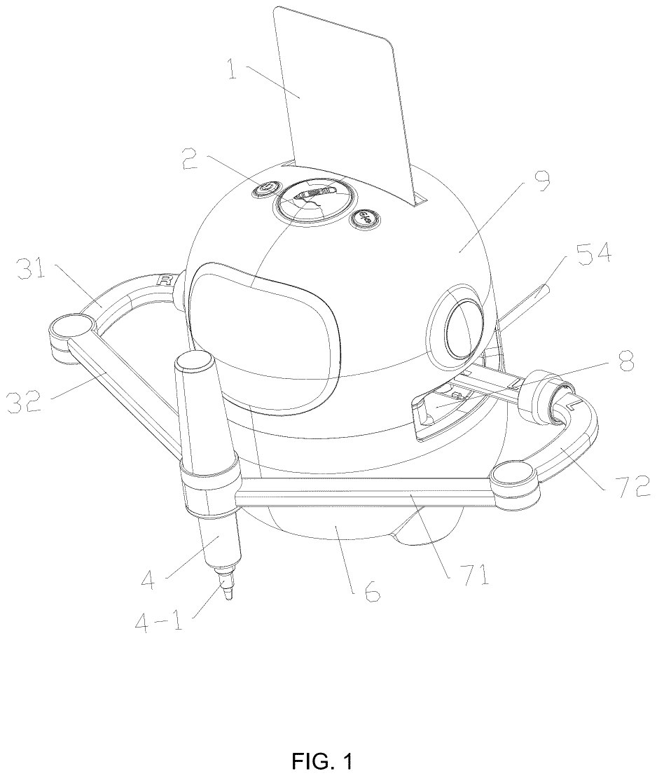

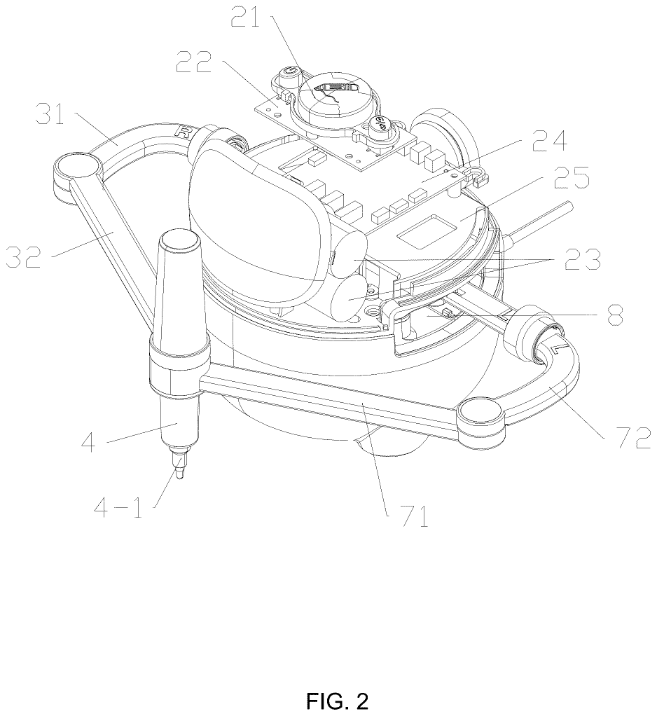

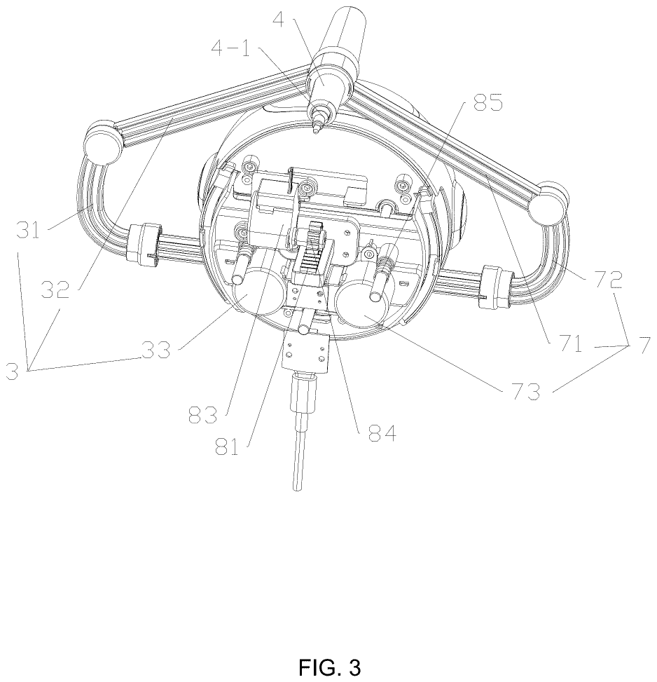

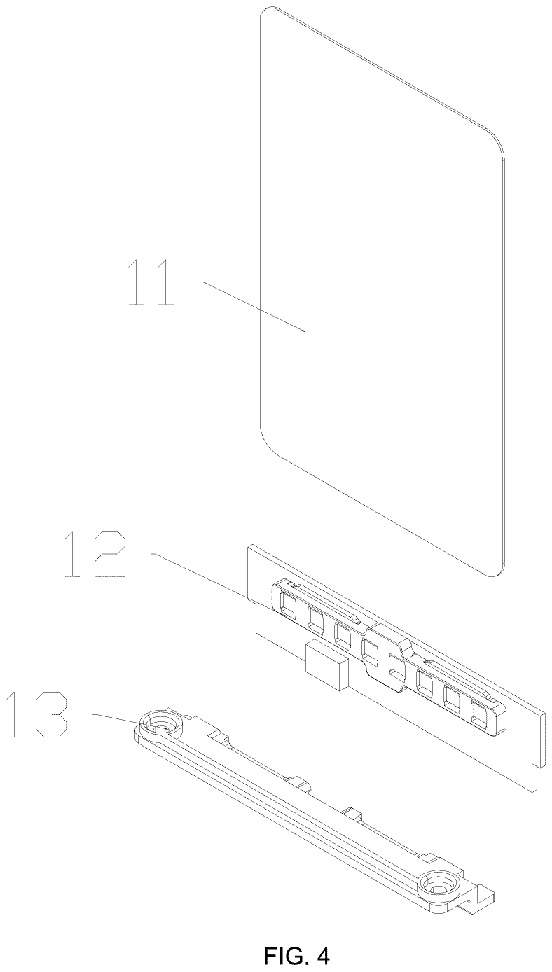

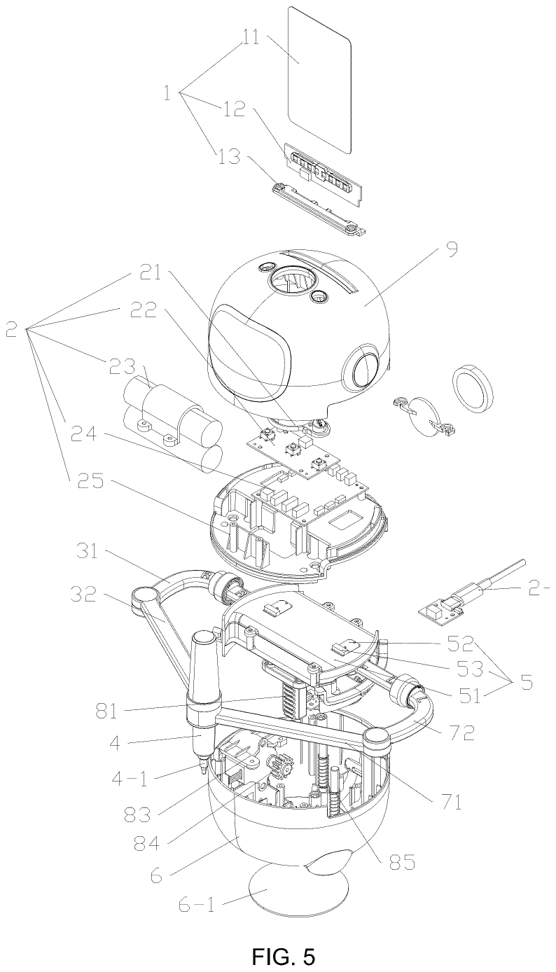

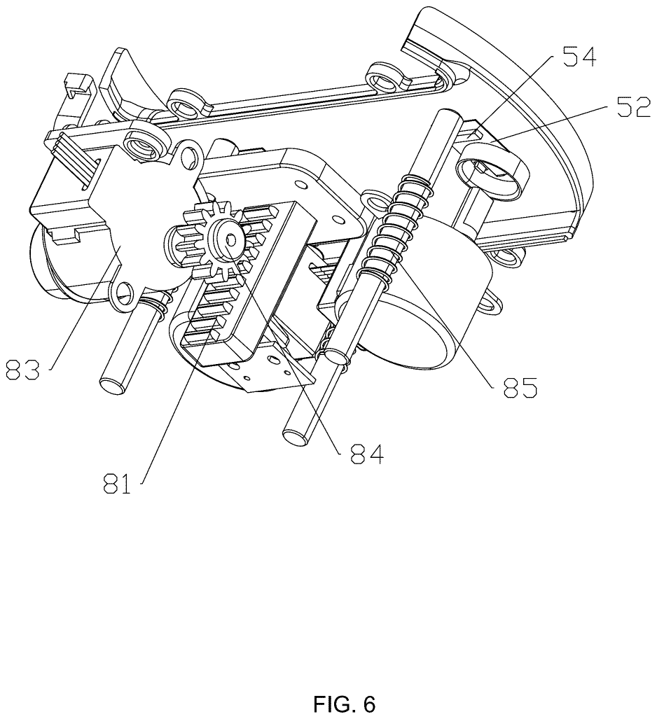

As shown in FIGS. 1-6:
1. Card recognition mechanism
2. Control and adjustment components
2-1. Charging power supply
3. Right arm component
4. Pen lock button
4-1. Drawing pen
5. Arm assembly
6. Main body lower shell
6-1. Anti-slip pad
7. Left arm component
8. Rising component
9. Main body upper shell
11. Card placement board
12. Recognition main board
13. Card recognition board bracket
21. Control button
22. Button PCBA board
23. Battery
24. mainboard PCBA board
25. isolation middle frame
31. right arm connecting rod
32. right forearm
33. right arm motor
51. arm connecting plate
52. magnetic coding switch
53. arm limit switch
54. magnet
71. left forearm
72. left arm connecting rod
73. left arm motor
81. rising component gear plate
82. floating motor fixing bracket
83. floating motor
84. transmission gear
85. floating guide column

While the technology is susceptible to various modifications and alternative forms, specifics thereof have been shown by way of example and drawings, and will be described in detail. It should be understood, however, that the application is not limited to the particular embodiments described. On the contrary, the application is to cover modifications, equivalents, and alternatives falling within the spirit and scope of the technology.

### DETAILED DESCRIPTION OF EMBODIMENTS

The embodiments of the present technology described herein are not intended to be exhaustive or to limit the technology to the precise forms platelosed in the following detailed description. Rather, the embodiments are chosen and described so that others skilled in the art can appreciate and understand the principles and practices of the present technology.

All publications and patents mentioned herein are hereby incorporated by reference. The publications and patents platelosed herein are provided solely for their platelosure. Nothing herein is to be construed as an admission that the inventors are not entitled to antedate any publication and/or patent, including any publication and/or patent cited herein.

The following is a further detailed description of a card-reading painting robot according to the present invention in conjunction with the accompanying drawings.

As shown in FIGS. 1-6, a card-reading painting robot, comprising a card recognition mechanism 1, a control and adjustment component 2, a right arm component 3, a pen lock button 4, an arm assembly 5, a left arm component 7 and a rising component 8. The lower part of the card recognition mechanism 1 is connected to the control and adjustment component 2. The control and adjustment component 2 is arranged on the arm assembly 5. The right arm component 3 is arranged on one side of the arm assembly 5. The left arm component 7 is arranged on one side of the arm assembly 5. The right arm component 3 and the left arm component 7 are both connected to the pen lock button 4. The lower part of the arm assembly 5 is arranged on the rising component 8.

The card recognition mechanism 1 comprising a card placement plate 11, a recognition main board 12 and a card recognition plate bracket 13. The card placement plate 11 is arranged on the recognition main board 12. The recognition main board 12 is connected to the control and adjustment component 2 through the card recognition plate bracket 13. The user places a card containing a drawing instruction on the card placement plate 11, and the recognition main board 12 reads the recognition card information, and the device can be turned on and off by the control and adjustment component 2.

The control and adjustment component 2 comprising a control button 21, a button PCBA board 22, a battery 23, a mainboard PCBA board 24 and an isolation middle frame 25. The control button 21 passes through the main body upper shell 9 and is arranged on the button PCBA board 22. The button PCBA board 22 is connected to the mainboard PCBA board 24. The mainboard PCBA board 24 is provided with a battery 23. The lower bolt of the mainboard PCBA board 24 is connected to the isolation middle frame 25.

The control button 21 is used to manually intervene or start the machine. The button PCBA board 22 receives the button signal and transmits it to the main board PCBA board 24 for processing. The main board PCBA board 24 acts as a core control unit. According to the card recognition result, the motion parameters of the right arm assembly 3 and the left arm assembly 7 are adjusted, and battery 23 is used to supply power.

The rising component 8 includes a rising component gear plate 81, a floating motor fixing bracket 82, a floating motor 83, a transmission gear 84 and a floating guide column 85. The upper part of the rising component gear plate 81 is arranged in the middle part below the arm connecting plate 51, and the rising component gear plate 81 is meshed with the transmission gear 84. The transmission gear 84 is arranged on the floating motor 83. The floating motor 83 is fixedly connected to the main body lower shell 6 of the main body through the floating motor fixing bracket 82. The floating guide column 85 is slidably matched with the arm connecting plate 51.

The floating motor 83 drives the rising assembly tooth plate 81 through the transmission gear 84, driving the entire arm assembly 5 to move vertically along the floating guide column 85 to adjust the painting height.

Specifically, when a painting tilt angle is required, the main board PCBA board 24 drives the floating motor 83 to lift or lower the arm assembly 5 through the transmission gear 84 and the rising assembly tooth plate 81, thereby changing the tilt angle of the drawing pen 4-1;

The rising assembly 8 is arranged on the main body lower shell 6, and the main body upper shell 9 is arranged above the main body lower shell 6.

An anti-slip pad 6-1 is arranged below the main body lower shell 6.

The arm assembly 5 includes an arm connecting plate 51, a magnetic coding switch 52, and an arm limit switch 53. A right arm assembly 3 is provided on one side of the arm connecting plate 51, and a left arm assembly 7 is provided on the other side of the arm connecting plate 51. The lower part of the arm connecting plate 51 is connected to the rising assembly 8. The arm connecting plate 51 is provided with a magnetic coding switch 52 and an arm limit switch 53. The arm limit switch 53 ensures that the arm movement is within a safe range. A magnet 54 is provided at the lower end of the magnetic coding switch 52, and the accuracy of arm assembly 5 can be controlled by the sensitivity of the current to the magnetic field.

The right arm assembly 3 is composed of a right arm connecting rod 31, a right forearm 32 and a right arm motor 33. The right arm motor 33 is arranged on the arm connecting plate 51. The right arm motor 33 is connected to the right forearm 32 through the right arm connecting rod 31. The right forearm 32 is arranged on the right side of the pen lock button 4.

The left arm assembly 7 is composed of a left forearm 71, a left-arm connecting rod 72 and a left arm motor 73. The left arm motor 73 is arranged on the arm connecting plate 51. The left arm motor 73 is connected to the left forearm 71 through the left arm connecting rod 72. The left arm connecting rod 72 is arranged on the left side of the pen lock button 4.

The right arm assembly 3 and the left arm assembly 7 are driven by their respective motors to achieve multi-angle, high-precision painting actions.

The pen lock button 4 is provided with a drawing pen 4-1.

The control and adjustment assembly 2 is provided with a charging power supply 2-1, and the charging power supply 2-1 is electrically connected to the battery 23.

In the specific implementation of the present invention,
when it is necessary to use this device for painting, the user should place the painting robot in a stable and safe place. After placing it, the user will be able to use the device normally.

When in use, the user only needs to insert the card into the card placement plate 11 and turn on the device through the control button 21. After the painting robot is turned on, the recognition motherboard 12 will recognize the content on the card. After the recognition motherboard 12 completes the recognition, it will transmit its data to the motherboard PCBA board 24. At this time, the motherboard PCBA board 24 will drive the right arm motor 33 and the left arm motor 73, and then control its right arm assembly 3 and the left arm assembly 7, so that the pen lock button 4 moves in a certain direction, to use the drawing pen 4-1 for painting.

When the drawing tilt angle is required, the main board PCBA board 24 drives the floating motor 83 to lift or lower the arm assembly 5 through the transmission gear 84 and the rising component gear plate 81, thereby changing the tilt angle of the drawing pen 4-1. When the battery 23 in the drawing robot is low on power, the user can charge it through the charging power supply 2-1.

A magnet 54 is provided at the lower end of the magnetic coding switch 52, which can control the accuracy of the drawing of arm assembly 5 through the sensitivity of the current to the magnetic field.

1. A card-reading painting robot, comprising a card recognition mechanism, a control and adjustment component, a right arm component, a pen lock button, an arm assembly, a left arm component and a lifting component; the lower part of the card recognition mechanism is connected to the control and adjustment component; the control and adjustment component is arranged on the arm assembly; wherein a right arm component is arranged on one side of the arm assembly; wherein a left arm component is arranged on one side of the arm assembly; both the right arm component and the left arm component are connected to the pen lock button; the lower part of the arm assembly is arranged on the lifting component;
wherein the card recognition mechanism includes a card placement plate, a recognition main board, and a card recognition plate bracket; the card placement plate is arranged on the recognition main board, which is connected to the control and adjustment component through the card recognition plate bracket;
wherein the control and adjustment assembly include a control button, a button PCBA board, a battery, a main board PCBA board, and an isolation middle frame; the control button passes through the main body's upper shell and is arranged on the button PCBA board; the button PCBA board is connected to the main board PCBA board, which is provided with a battery; the lower bolt of the main board PCBA board is connected to the isolation middle frame;
wherein the lifting component includes a lifting component tooth plate, a floating motor fixing bracket, a floating motor, a transmission gear, and a floating guide rail column; the upper part of the lifting component tooth plate is arranged in the middle part below the arm connecting plate, and the lifting component tooth plate meshes with the transmission gear; the transmission gear is placed on the floating motor; the floating motor is fixedly connected to the lower shell of the main body through the floating motor fixing bracket; the floating guide rail column is slidably matched with the arm connecting plate.

2. The card-reading painting robot of claim 1, wherein the rising assembly is arranged on the main body lower shell, and the main body upper shell is arranged above the main body lower shell.

3. The card-reading painting robot of claim 2, wherein a non-slip pad is provided below the lower shell of the main body.

4. The card-reading painting robot of claim 1, wherein the arm assembly comprises an arm connecting plate, a magnetic coding switch, and an arm limit switch; wherein a right arm assembly is arranged on one side of the arm connecting plate, and a left arm assembly is placed on the other side of the arm connecting plate; the lower part of the arm connecting plate is connected to the rising assembly; wherein a magnetic coding switch and an arm limit switch are arranged on the arm connecting plate; wherein a magnet is placed at the lower end of the magnetic coding switch.

5. The card-reading painting robot of claim 4, wherein the right arm assembly is composed of a right arm connecting rod, a right forearm and a right arm motor; the right arm motor is arranged on the arm connecting plate; the right arm motor is connected to the right forearm through the right arm connecting rod; the right forearm is arranged on the right side of the pen lock button.

6. The card-reading painting robot of claim 1, wherein the left arm assembly is composed of a left forearm, a left arm connecting rod and a left arm motor; the left arm motor is arranged on the arm connecting plate; the left arm motor is connected to the left forearm through the left arm connecting rod; the left arm connecting rod is arranged on the left side of the pen lock button.

7. The card-reading painting robot of claim 1, wherein the pen lock button is provided with a drawing pen.

8. The card-reading painting robot of claim 1, wherein the control and adjustment component are provided with a charging power supply, and the charging power supply is electrically connected to the battery.
